(19) United States
(12) Patent Application Publication
(10) Pub. No.: US 2010/0160840 A1
(43) Pub. Date: Jun. 24, 2010

(54) Massage Device

(76) Inventor: Trevor Murphy, Enniscorthy (IE)

Correspondence Address: Husch Blackwell Sanders Welsh & Katz, 22nd Floor, 120 South Riverside Plaza, Chicago, IL, 60606-3945, US

(21) Appl. No.: 12/565,237

(22) Filed: Sep. 23, 2009

(30) Foreign Application Priority Data
Dec. 23, 2008 (GB) 0823488.2

(51) Int. Cl. A61H 15/00

(52) U.S. Cl. 601/112

(57) ABSTRACT

A massage device comprising: a housing with a removable cover; a wheel rotatably mounted inside the housing so that it can rotate about an axis of rotation, the wheel having a series of tongues; wherein the cover can be removed to form an opening in the housing and the wheel can be rotated so that at least part of each tongue periodically protrudes from the opening. The massage device is particularly useful for genital stimulation.

### FIELD OF THE INVENTION

The present invention relates to a massage device and a method for using such a massage device.

### BACKGROUND OF THE INVENTION

WO 94/04117 describes a massage device, in particular for erogenous zones. The device has a spherical housing with a slot-like aperture. Mounted inside the housing is a wheel which is driven by an electric motor. The wheel has a series of tongues which, when the wheel turns, are rotated so that they periodically protrude from the aperture.

A first problem with the device of WO 94/04117 is that the diameter of the housing is relatively large compared with the diameter of the wheel. Therefore either the wheel has to be relatively small (which results in a poor massaging action) or the housing must be relatively large (which makes the device difficult to store, and to hold during use).

A second problem with the device of WO 94/04117 is that no means is provided to clean or replace the wheel.

A third problem with the device of WO 94/04117 is that the wheel remains exposed after it has been used, so can accumulate dirt.

### SUMMARY OF THE INVENTION

A first aspect of the invention provides a massage device comprising:
a housing with a removable cover;
a wheel rotatably mounted inside the housing so that it can rotate about an axis of rotation, the wheel having a series of tongues;
   wherein the cover can be removed to form an opening in the housing, and wherein the wheel is positioned so that at least part of each tongue periodically protrudes from the opening as the wheel is rotated with the cover removed.

A further aspect of the invention provides a method of using the device, the method comprising removing the cover to form an opening in the housing; rotating the wheel so that at least part of each tongue periodically protrudes from the opening; and massaging part of the human body with the tongues.

A further aspect of the invention provides a massage device comprising:
a housing with an opening and a removable panel; and
a wheel rotatably mounted inside the housing so that it can rotate about an axis of rotation, the wheel having a series of tongues,
   wherein the wheel is positioned so that at least part of each tongue periodically protrudes from the opening as the wheel is rotated, wherein the axis of rotation of the wheel passes through the removable panel, and wherein the wheel can be removed from the housing by moving the panel to form a lateral opening in the housing and removing the wheel through the lateral opening.

A further aspect of the invention provides a method of using the device, the method comprising rotating the wheel so that at least part of each tongue periodically protrudes from the opening; and massaging part of the human body with the tongues.

A further aspect of the invention provides a method of dismantling the device, the method comprising moving the panel to form a lateral opening in the housing, and removing the wheel through the lateral opening.

A further aspect of the invention provides a method of replacing the wheel in the device, the method comprising dismantling the device; mounting a replacement wheel in the housing; and closing the lateral opening with the movable panel.

In the preferred embodiment described below, the panel is completely removed from the housing to dismantle the device. However, in an alternative embodiment (not shown) the panel may be pivotally mounted to the housing so that it remains attached when the housing is opened.

### BRIEF DESCRIPTION OF THE DRAWINGS

Embodiments of the invention will now be described with reference to the accompanying drawings, in which:

FIG. 1 is a left side elevation view of a massage device;

FIG. 2 is a left side elevation view of the massage device of FIG. 1 with its cover removed;

FIG. 3 is a left side elevation view of the wheel which forms part of the massage device of FIGS. 1 and 2;

FIG. 4 is a perspective view of the left side of the wheel of FIG. 3;

FIG. 5 is an exploded perspective view of the massage device of FIGS. 1 and 2;

FIG. 5a is a detailed view of the attachment mechanism of a removable panel of the massage device;

FIG. 5b is a sectional view of the attachment mechanism across line B-B indicated in FIG. 5a;

FIG. 6 is a right side elevation view of the wheel

FIG. 7 is a perspective view of the right side of the wheel; and

FIG. 8 is an exploded perspective view of the massage device of FIGS. 1 and 2 illustrating how batteries are inserted into the massage device.

### DETAILED DESCRIPTION OF EMBODIMENT(S)

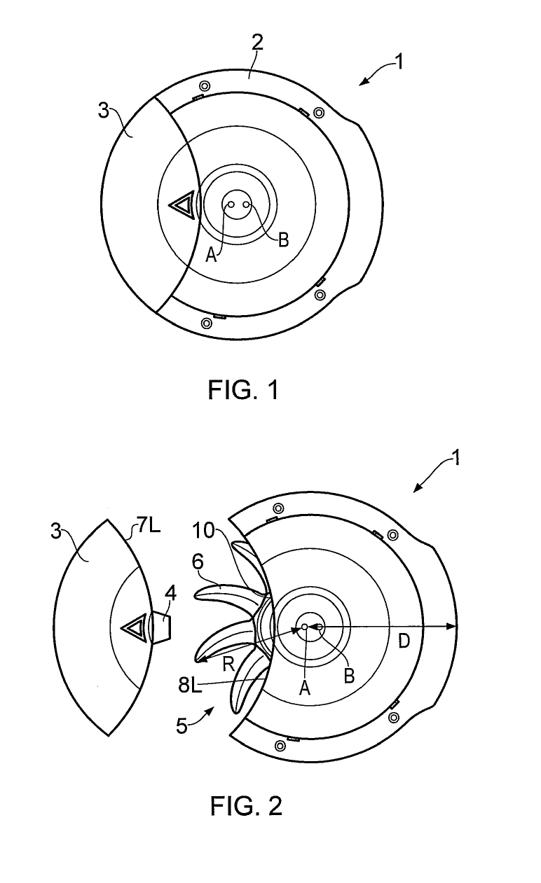

FIGS. 1 and 2 are left side elevation views of a massage device 1 having a housing with a body 2 and a removable cover 3. The cover 3 is attached to the body 2 by a pair of snap-fit connectors 4 (only one of which is shown in FIG. 2). When the cover 3 is removed, an opening 5 is aimed in the housing to expose the front part of a wheel 6 as shown in FIG. 2.

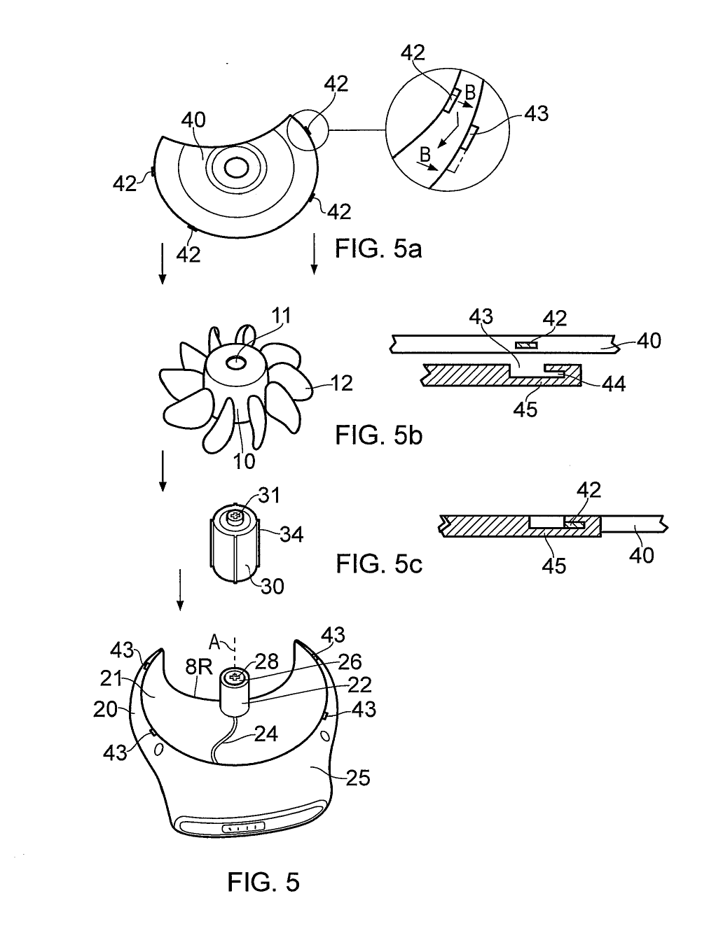

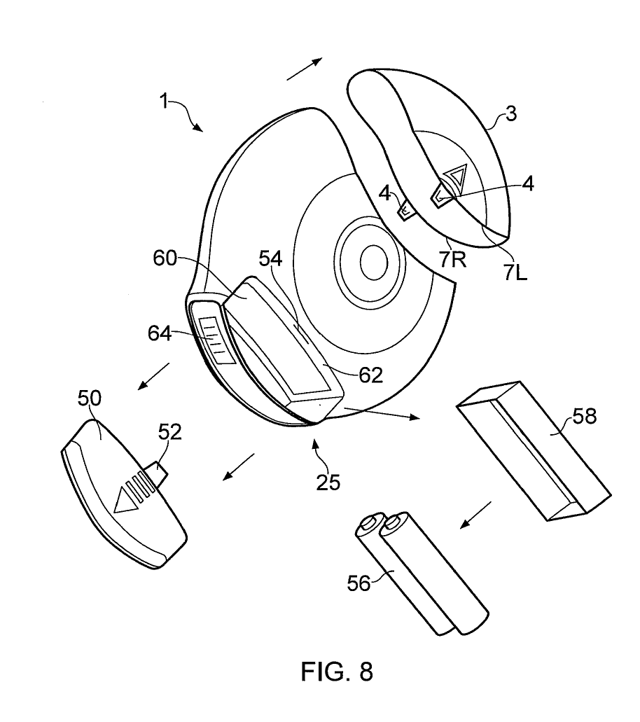

The cover 3 has a left side wall with an edge 7L shown in FIG. 2 and a right side wall with an edge 7R shown in FIG. 8. The body 2 has a left side wall with an edge 8L which forms a left side of the opening 5 and a right side wall with an edge 8R (shown in FIG. 5) which forms a right side of the opening 5. When the cover 3 is attached to the body, its edges 7L, 7R engage the edges 8L, 8R of the opening 5. As shown in FIGS. 1 and 2, when viewed in side elevation in a direction parallel to the axis of rotation of the wheel, the edges 7L, 7R of the cover 3 appear convex in shape while the edges 8L, 8R of the body 2 appear concave in shape.

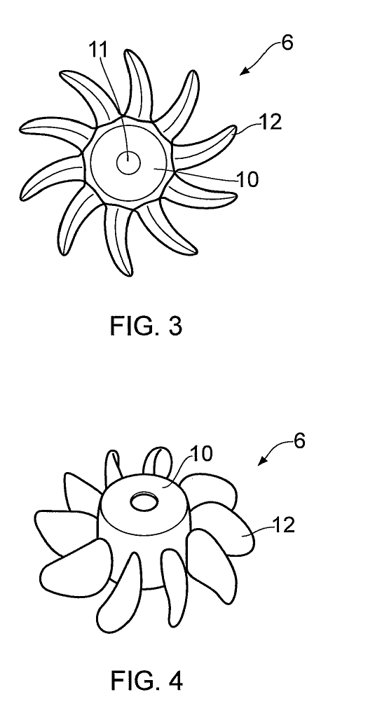

Referring to FIGS. 3 and 4, the wheel 6 has a cylindrical boss 10 with an axial hole 11. A series of curved silicone tongues 12 extend radially from the outer diameter of the boss 10. The wheel 6 is mounted to a drive axle inside the housing which rotates the wheel about an axis of rotation when the massage device is in use (see below). The wheel 6 is positioned so that, when the wheel rotates, each of the tongues 12 periodically protrudes from the opening 5 in the housing 2. The protruding tongues 12 are particularly suitable for massaging erogenous zones of the human body and, in particular, for female genital stimulation. In this example, the boss 10 can be seen in the side view of FIG. 2, so the whole of each tongue 12 periodically protrudes from the opening 5. In an alternative arrangement (not shown) the cover and body may be shaped so that only the distal tips of the tongues 12 protrude from the opening 5. Between uses, the removable cover 3 can be re-attached to help keep the tongues 12 clean.

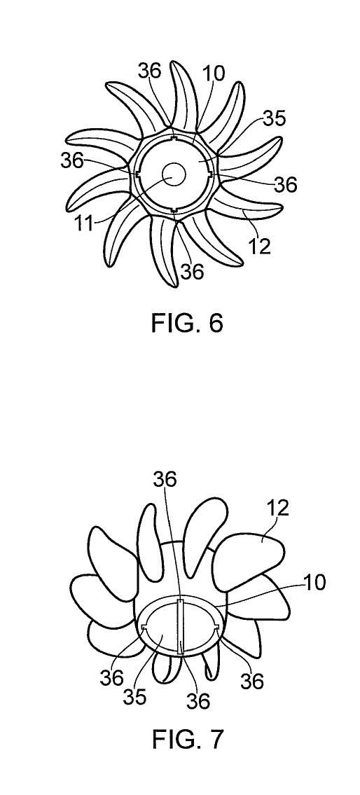

FIG. 5 is an exploded view of the massage device 1, with the removable cover 3 omitted. The body 2 has a base 20 with a lateral opening 21 on its left side and an electric motor 22 with a cylindrical drive axle 26 mounted on its right side. An X-shaped projection 28 extends from a distal end of the drive axle 26. When the massage device is in use, the axle 26 is rotated about an axis of rotation A by the electric motor 22. Power is provided to the motor by cables 24 which extend from a battery compartment 25 positioned at the rear of the housing. A hollow sleeve 30 is fitted over the motor axle 22. The X-shaped projection 28 on the drive axle 26 engages with a corresponding X-shaped recess (not shown) in the sleeve 30 to prevent the sleeve from rotating relative to the drive axle 26. The sleeve 30 has a series of ridges 34 projecting from its outer perimeter and extending along its length. As shown in FIGS. 6 and 7, which show the right hand side of the wheel 6, the boss 10 has a bore 35 with a corresponding series of slots 36, also extending along its length.

Thus the wheel 6 is fitted onto the sleeve 30 by slotting the ridges 34 into the slots 36. The interaction between the ridges 34 and the slots 36 causes the wheel 6 to rotate with the sleeve 30 and axle 22 and ensures that there is no relative rotation between them. The sleeve 30 also has a boss 31 which fits snugly through the axial hole 11 in the boss 10.

The left-hand side of the body 2 of the housing is formed by a removable panel 40. The base 20 has four notches 43 each having a base 45 and an associated slot 44 as shown in the sectional view of FIG. 5b. The panel 40 has four tabs 42. The panel 40 is mounted by inserting the tabs 42 into the notches 43 until the tabs 42 engage the bases 45 of the notches. Then the panel 40 is rotated clockwise relative to the base 20 as shown by the arrow in FIG. 5a so that the tabs 42 slide into the slots 44.

The panel 40 can be removed by rotating it anticlockwise until the tabs 42 are re-aligned with the notches 43 and lifting it off in a direction parallel to the wheel's axis of rotation. When the panel 40 has been removed, the wheel 6 can be removed from the housing through the lateral opening 21 by sliding it off the axle 22 (with or without the sleeve 30) in a direction parallel to the axis of rotation A of the wheel 6. The wheel 6 can then be cleaned and returned to the device, or may be replaced with a different wheel with, for example, differently shaped tongues. After the wheel has been replaced, the removable panel 40 can be re-attached to the base 20.

FIG. 8 is an exploded perspective view of the massage device 1, the wheel 6 being omitted for clarity. As indicated above, a battery compartment 25 is provided at the rear of the housing 2. A removable panel 50 is provided to allow the batteries to be easily changed. The removable panel 50 is attachable to the battery compartment 25 by a snap fit connector 52 which can be inserted into a slot 54 in the housing 2. A pair of batteries 56 are inserted into a case 58 which is then inserted into the battery compartment 25. Electrical connections (not shown) are provided between the terminals of the batteries 56 and a circuit board 60 which is positioned on an internal wall 62 of the battery compartment 25. The circuit board 60, along with the cables 24, acts as an interface between the batteries and the electric motor used to rotate the wheel 6 when the device is in use.

Also shown in FIG. 8 is a switch 64 which is also connected to the circuit board 60. The switch 64, which controls the operation of the motor, has at least two positions: on and off. Additionally, the switch 64 may have a range of intermediate positions which cause different voltages to be applied to the motor, thus making the wheel 6 rotate at different speeds.

As shown in FIG. 1, the upper and lower edges of the body 2 and the front edge of the cover 3 are shaped to form an arc of a circle when viewed in side elevation in a direction parallel to the axis of rotation of the wheel, the centre of the arc being positioned approximately on the axis of rotation A of the wheel. Moreover, again in this side elevation view, the axis of rotation A of the wheel 6 is in close proximity to the geometric centre B of the housing. As can be appreciated from FIG. 2, the distance between A and B is much less than the radius R of the wheel. This makes the device compact which makes storing and using the device easy. As shown in FIG. 2, when the device is viewed in side elevation, the longest distance D between the axis of rotation A and an external edge of the housing is less than twice the radius R of the wheel (in this example D is approximately 125% of R).

Although the invention has been described above with reference to one or more preferred embodiments, it will be appreciated that various changes or modifications may be made without departing from the scope of the invention as defined in the appended claims.

1. A massage device comprising:
a housing with a removable cover;
a wheel rotatably mounted inside the housing so that it can rotate about an axis of rotation, the wheel having a series of tongues;
wherein the cover can be removed to form an opening in the housing, and wherein the wheel is positioned so that at least part of each tongue periodically protrudes from the opening as the wheel is rotated with the cover removed.

2. The device of claim 1 wherein the housing has a geometric centre and wherein when viewed in side elevation in a direction parallel to the axis of rotation of the wheel the distance between the axis of rotation of the wheel and the geometric centre of the housing is less than the radius of the wheel.

3. The device of claim 2 wherein when viewed in side elevation in a direction parallel to the axis of rotation of the wheel the distance between the axis of rotation of the wheel and the geometric centre of the housing is less than half the radius of the wheel.

4. The device of claim 1 wherein when viewed in side elevation in a direction parallel to the axis of rotation of the wheel the longest distance between the axis of rotation of the wheel and an external edge of the housing is less than twice the radius of the wheel.

5. The device of claim 1 wherein the cover has an edge which engages an edge of the opening in the housing, wherein the edge of the cover appears convex when viewed in side elevation in a direction parallel to the axis of rotation of the wheel, and wherein the edge of the opening in the housing appears concave when viewed in side elevation in a direction parallel to the axis of rotation of the wheel.

6. The device of claim 1 wherein at least part of the housing is shaped to form an arc of a circle when viewed in side elevation in a direction parallel to the axis of rotation of the wheel.

7. The device of claim 6 wherein at least part of the housing is shaped to form a first arc of a circle when viewed in side elevation in a direction parallel to the axis of rotation of the wheel; wherein at least part of the cover is shaped to form a second arc of a circle when viewed in side elevation in a direction parallel to the axis of rotation of the wheel, and wherein the first and second arcs are centred at substantially the same point.

8. The device of claim 1 further comprising a motor for rotating the wheel, the motor having a drive axle which is substantially concentric with the axis of rotation of the wheel.

9. The device of claim 1 further comprising a removable panel in the housing, wherein the axis of rotation of the wheel passes through the removable panel and wherein the wheel can be removed from the housing by removing the panel to form a lateral opening in the housing and removing the wheel through the lateral opening.

10. The device claim 1 wherein the cover is attached by a snap-fit connection.

11. A method of using the device of claim 1, the method comprising removing the cover to form an opening in the housing; rotating the wheel so that at least part of each tongue periodically protrudes from the opening; and massaging part of the human body with the tongues.

12. The method of claim 11 wherein the tongues are used for female genital stimulation.

13. A massage device comprising:
a housing with an opening and a removable panel; and
a wheel rotatably mounted inside the housing so that it can rotate about an axis of rotation, the wheel having a series of tongues,
wherein the wheel is positioned so that at least part of each tongue periodically protrudes from the opening as the wheel is rotated, wherein the axis of rotation of the wheel passes through the removable panel, and wherein the wheel can be removed from the housing by moving the panel to form a lateral opening in the housing and removing the wheel through the lateral opening.

14. The device of claim 13 wherein the wheel can be removed from the housing through the lateral opening in a direction parallel to the axis of rotation of the wheel.

15. The device of claim 13 wherein the wheel has a bore which receives an axle; wherein the bore and the axle have interconnecting parts which prevent the bore from rotating relative to the axle; and wherein the wheel can be removed from the housing by sliding the bore off the axle.

16. A method of using the device of claim 13, the method comprising rotating the wheel so that at least part of each tongue periodically protrudes from the opening; and massaging part of the human body with the tongues.

17. The method of claim 16 wherein the tongues are used for female genital stimulation.

18. A method of dismantling the device of claim 13, the method comprising moving the panel to form a lateral opening in the housing, and removing the wheel through the lateral opening.

19. The method of claim 18 wherein the wheel is removed from the housing through the lateral opening in a direction parallel to the axis of rotation of the wheel.

20. A method of replacing the wheel in the device of claim 13, the method comprising dismantling the device by the method of claim 18; mounting a replacement wheel in the housing; and closing the lateral opening with the removable panel.
